(19) United States
(12) Patent Application Publication
(10) Pub. No.: US 2010/0321498 A1
(43) Pub. Date: Dec. 23, 2010

(54) Surveillance and Recording Device Through an Original Power Outlet

(76) Inventor: Yu-Li KAO, Yonghe City (TW)

Correspondence Address: Muncy, Geissler, Olds & Lowe, PLLC, 4000 Legato Road, Suite 310, FAIRFAX, VA, 22033, US

(21) Appl. No.: 12/189,181

(22) Filed: Aug. 10, 2008

(51) Int. Cl. H04N 7/18

(52) U.S. Cl. 348/151; 348/E07.085

(57) ABSTRACT

A surveillance and recording device through an original power outlet includes a photographing device as well as a display and recording device. The photographing device contains an image module, an image compression module and a first power line adapter module. The display and recording device includes a display and recording module, a storage device, a processor, an image decompression module and a second power line adapter module. The photographing device is installed in lighting and photographing equipment (e.g., a lamp-set or a night lamp) with a holding space, and a power connector of the lighting and photographing equipment fits with an ordinary power outlet. Therefore, having a photographing and surveillance function and able to be installed at an ordinary power outlet, the lighting and photographing equipment has a disguise effect, and enables a surveillance and recording system to be installed easily without setting up an image transmission wire.

### BACKGROUND OF THE INVENTION

a) Field of the Invention

The present invention relates to a surveillance and recording device, and more particularly to lighting and photographing equipment which is provided with a photographing and surveillance function and can be installed at an ordinary power outlet, wherein the lighting and photographing equipment is not only provided with a disguise effect, but also allows a surveillance and recording system to be easily installed without setting up a image transmission wire.

b) Description of the Prior Art

As a criminal skill is changing everyday, the popularity and importance of a surveillance and recording system are also increasing accordingly. However, for a camera which is sold on an ordinary market, its appearance is very easy to be identified that covertness required for the surveillance device will be lost and the camera can be found out easily by people with intentions to destroy or dodge from it. In addition, a power cable and an image transmission wire that are connected to the surveillance device can be damaged easily. Therefore, a meaning for existence of the surveillance device will disappear.

### SUMMARY OF THE INVENTION

Accordingly, the primary object of the present invention is to provide a surveillance and recording device through an original power outlet, which is lighting and photographing equipment that is provided with a photographing and surveillance function and can be installed at an ordinary power outlet. This lighting and photographing equipment is not only provided with a disguise effect, but also allows a surveillance and recording system to be easily installed without setting up an image transmission wire. The surveillance and recording device through the original power outlet of the present invention includes a photographing device as well as a display and recording device, wherein the photographing device is built in with an image module, an image compression module and a first power line adapter module. On the other hand, the display and recording device is built in with a display and recording module, a storage device, a processor, an image decompression module and a second power line adapter module. The photographing device is installed in the lighting and photographing equipment (e.g., a lamp-set or a night lamp) that is provided with a holding space; whereas, a power connector of the lighting and photographing equipment fits with an ordinary power outlet. Accordingly, as the lighting and photographing equipment is provided with the photographing and surveillance function and can be installed at the ordinary power outlet, that lighting and photographing equipment is not only provided with the disguise effect, but also enables the surveillance and recording system to easily installed without setting up the image transmission wire.

Another object of the present invention is to provide a surveillance and recording device through an original power outlet, wherein as the power line adapter modules are directly built into a network camera and a network video recorder, a network connection can be accomplished through a power line just by providing power to the network camera and the network video recorder; whereas, images of the network camera can be transmitted to the network video recorder through the network connection.

Still another object of the present invention is to provide a surveillance and recording device through an original power outlet, which, as described above, allows a user to easily accomplish the installation of the surveillance and recording system just by providing power to the network camera and the network video recorder.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of a structure of the present invention.

FIG. 2 shows a schematic view of a photographing device structure of a preferred embodiment of the present invention.

FIG. 3 shows a schematic view of a structure of a display and recording device of a preferred embodiment of the present invention.

FIG. 4 shows a cutaway view of a photographing device structure of a preferred embodiment of the present invention.

FIG. 5 shows a schematic view of a network connection of a preferred embodiment of the present invention.

FIG. 6 shows a schematic view of a network connection of another preferred embodiment of the present invention.

### DETAILED DESCRIPTION OF THE PREFERRED EMBODIMENTS

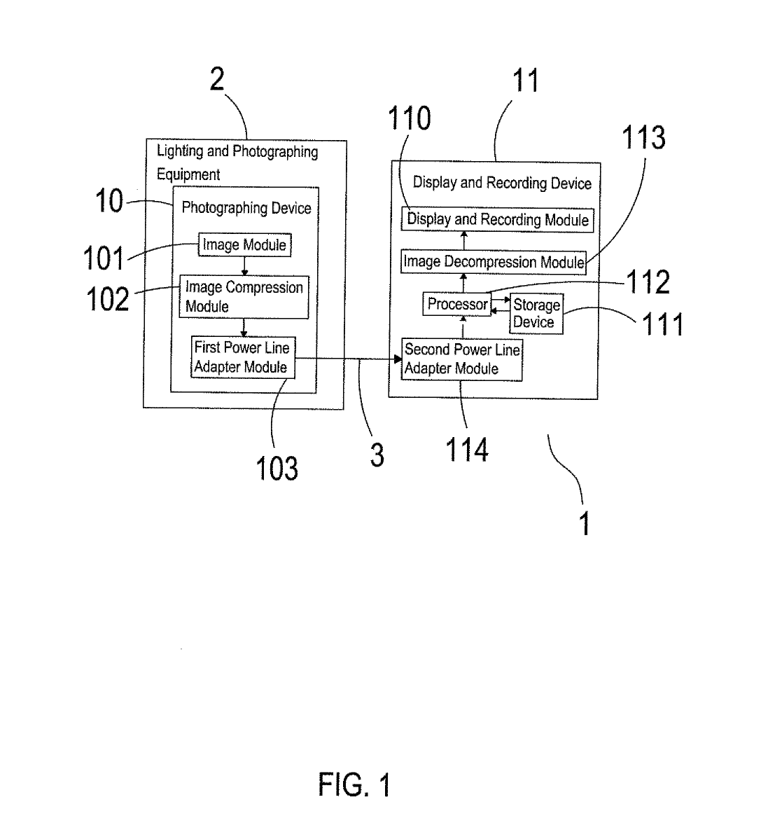

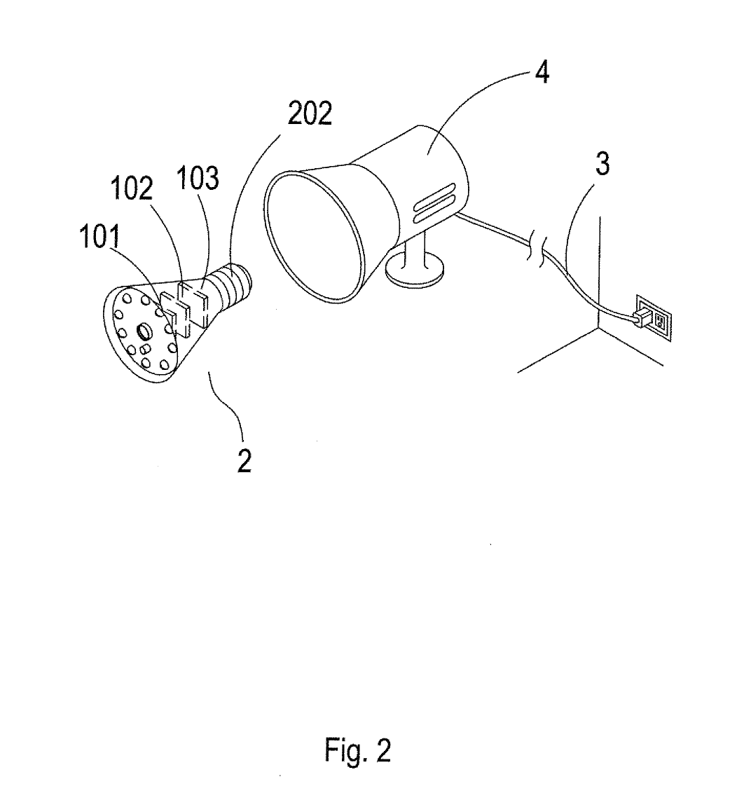

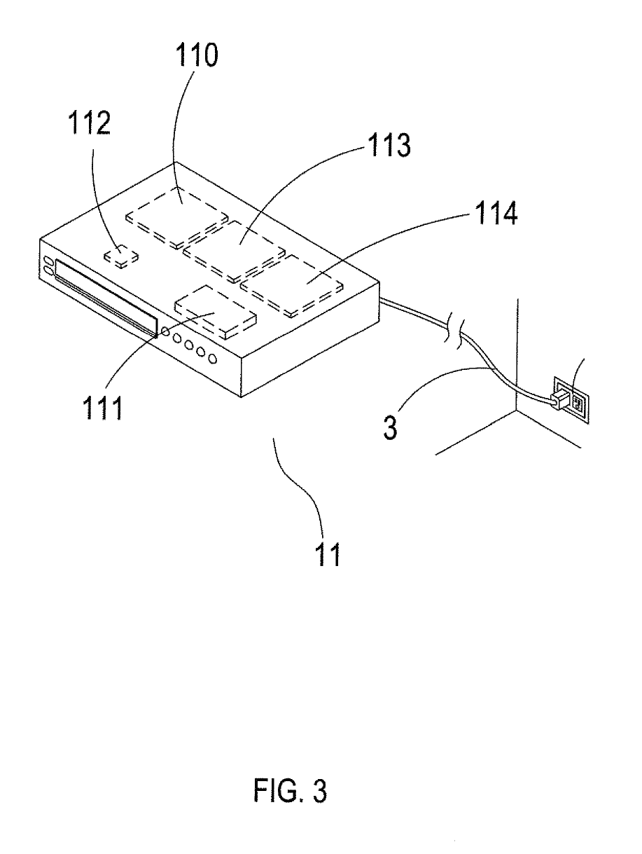

Referring to FIGS. 1 to 3, it shows a block diagram of a structure, a schematic view of a photographing device structure and a schematic view of a structure of a display and recording device, of the present invention, wherein a surveillance and recording device 1 comprises primarily a photographing device 10 as well as a display and recording device 11. The photographing device 10 is built in with an image module 101, an image compression module 102 and a first power line adapter module 103. In addition, the display and recording device 11 is built in with a display and recording module 110, a storage device 111, a processor 112, an image decompression module 113 and a second power line adapter module 114. The photographing device 10 is installed in lighting and photographing equipment 2 (e.g., an LED lamp-set or a night lamp), and a power connector 202 of that lighting and photographing equipment 2 fits with an ordinary power outlet 4.

Accordingly, the first power line adapter module 103 and the second power line adapter module 114 are connected with a default power line 3. When the power line 3 is electrically connected with the photographing device 10, the first power line adapter module 103 and the second power line adapter module 114 will supply power and a network connection to the photographing device 10 as well as the display and recording device 11. As the photographing device 10 is built in with the image module 101, the image compression module 102 and the first power line adapter module 103, with the image module 101 containing a CCD (Charge Coupled Device) or a CMOS (Complementary Metal-Oxide Semiconductor) and being provided with an image processing function, multimedia information received by the image module 101 will be compressed as a default format through the image compression module 102, and then the compressed information of the multimedia information will be transmitted to the display and recording device 11 for storage or playing, through the power line 3, by using the first power line adapter module 103.

Referring to FIGS. 1 to 4, it shows a block diagram of a structure, a schematic view of a photographing device structure, a schematic view of a structure of a display and recording device and a cutaway view of a photographing device structure, of the present invention. The aforementioned photographing device 10 is installed in the lighting and photographing equipment 2, such as an LED lamp-set which includes a lamp shell 20 and a substrate 21, wherein an interior of the lamp shell 20 is defined into a holding space 201 to place the photographing device 10; an end of the lamp shell 20 is provided with the power connector 202 which fits with the ordinary power outlet 4; a ring of a plurality of light source elements 5, which can be LED lamps 50, is provided on the substrate 21, with the LED lamps 50 being a visible light lamp or an infrared lamp; a light sensor 6 which can detect intensity of ambient light rays and can automatically activate the LED lamps 50 is provided on the substrate 21; and a default location on the substrate 21 is defined into an opening 210 where a lens 7 is located to connect with the photographing device 10. Therefore, by installing the photographing device 10 into the LED lamp-set that is provided with the power connector 202 fitting with the ordinary power outlet 4, a user can just install the lighting and photographing equipment 2 at the ordinary power outlet 4 with the power connector 202, disregarding any situation, to achieve the functions of lighting and surveillance. In a mean time, as the photographing device 10 is installed in the ordinary lighting and photographing equipment 2, the effect of disguise can be achieved, too.

Moreover, as the display and recording device 11 is built in with the display and recording module 110, the storage device 111, the processor 112, the image decompression module 113 and the second power line adapter module 114, when the compressed information of the multimedia information is transmitted through the power line 3, the information is received by the display and recording device 11 from the second power line adapter module 114, and is processed by the processor 112 before being stored into the storage device 111. If the user is to play that information, the compressed information of the multimedia information, which has been stored in the storage device 111, can be also transmitted by the processor 112 to the image decompression module 113 for decompression, and is then interpreted before being played through the display and recording module 110. The display and recording device 110 can be an NVR (network video recorder) or other device.

On the other hand, as the first power line adapter module 103 and the second power line adapter module 114 are mutually connected with the power line 3 to form Ethernet, the user can use the first power line adapter module 103 and the second power line adapter module 114 to carry out a network connection, and can also use that Ethernet as a media for data transmission.

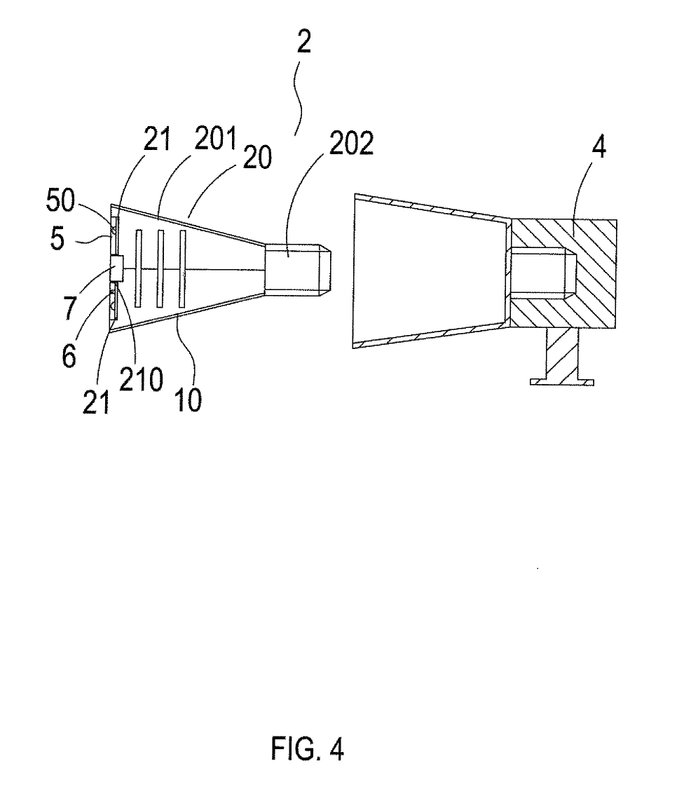

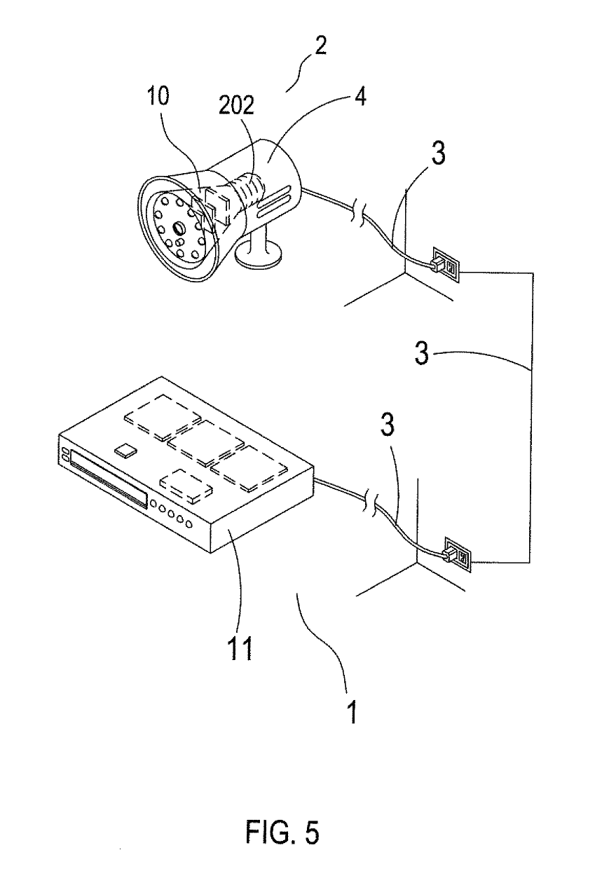

Referring to FIGS. 4 and 5, it shows a cutaway view of a photographing device structure and a schematic view of a network connection, of the present invention. Taking an LED lamp-set as an example of the lighting and photographing equipment 2, when the user is to activate the LED lamp-set, he or she can just put the power connector 202 on the LED lamp-set into the ordinary power outlet 4, and then the LED lamp-set will be energized and the internal photographing device 10 will be activated. At a same time, the photographing device 10 is connected from the network to the display and recording device 11 through the power line 3. As the substrate 21 on the LED lamp-set is provided with the plural LED lamps 50 which are automatically activated by the light sensor 6, with the intensity of ambient light rays being detected through the light sensor 6; the lighting and photographing equipment 2, which is provided with the photographing and surveillance function and can be installed at the ordinary power outlet 4, is not only provided with the disguise effect, but also can achieve the function for ambient environment surveillance.

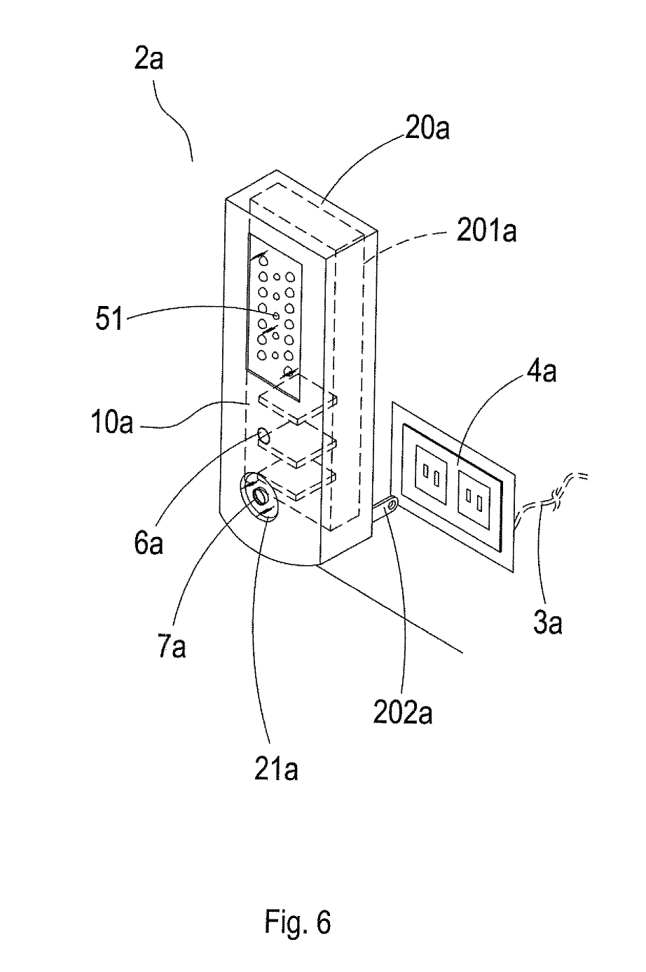

Referring to FIG. 6, it shows a schematic view of a network connection of another preferred embodiment of the present invention. Taking a night lamp as an example of the lighting and photographing equipment 2a, an interior of a lamp shell 20a is defined into a holding space 201a for placing the photographing device 10a, and a default position of the lamp shell 20a is provided with a lens 7a. When the user is to activate the night lamp, he or she can just put a power connector 202a on the night lamp into an ordinary power outlet 4a, and then the night lamp can be energized and an internal photographing device 10a can be activated. At a same time, the photographing device 10a is connected from a network to the display and recording device 11 (as shown in FIG. 5) through a power line 3a. As a substrate 21a on the night lamp is provided with a plurality of infrared lamps 51 which are activated automatically through a light sensor 6a, with the intensity of ambient light rays being detected through the light sensor 6a; the lighting and photographing equipment 2a, which is provided with the photographing and surveillance function and can be installed at the ordinary power outlet 4a, is not only provided with the disguise effect, but also can achieve the function for ambient environment surveillance.

Referring to all the drawings, the present invention is actually provided with following advantages in comparison with the prior art:
1. By being provided with the photographing and surveillance function and able to be installed at the ordinary power outlet 4, the lighting and photographing equipment 2 is not only provided with the disguise effect, but also allows the surveillance and recording system to be easily installed without setting up the image transmission wire.
2. As the first power line adapter module 103 and the second power line adapter module 114 are directly built in the photographing device 10 as well as the display and recording device 11, the user can only provide power to the photographing device 10 as well as the display and recording device 11 that the network connection is accomplished by the power line 3; whereas, the images of the photographing device 10 can be transmitted to the display and recording device 11 through the network connection. Therefore, the surveillance and recording system can be installed easily without setting up the image transmission wire.
3. Using the network connection to transmit the multimedia information to the display and recording device 11 will not result in attenuation of wireless signals in a various degree by shielding objects, when data is transmitted through a wireless network.

To enable a further understanding of the said objectives and the technological methods of the invention herein, the brief description of the drawings below is followed by the detailed description of the preferred embodiments.

What is claimed is:

1. A surveillance and recording device through an original power outlet, comprising a photographing device as well as a display and recording device, wherein the photographing device is built in with an image module, an image compression module and a first power line adapter module, whereas, the display and recording device is built in with a display and recording module, an image decompression module and a second power line adapter module; the photographing device being installed in lighting and photographing equipment that is provided with a holding space, and a power connector of the lighting and photographing equipment fitting with an ordinary power outlet.

2. The surveillance and recording device through an original power outlet, according to claim 1, wherein the lighting and photographing equipment is a lamp-set comprising a lamp shell, which is defined into a holding space to place the photographing device, and an end of which is provided with the power connector that fits with the ordinary power outlet; and a substrate, which is provided with a ring of a plurality of light source elements, and a default location of which is defined into an opening where a lens is located to connect with the photographing device.

3. The surveillance and recording device through an original power outlet, according to claim 2, wherein the light source element is provided with a ring of a plurality of LED (Light Emitting Diode) lamps which are activated automatically through a light sensor, with brightness of ambient environment being detected by that light sensor.

4. The surveillance and recording device through an original power outlet, according to claim 2, wherein the light source element is provided with a ring of a plurality of LED lamps.

5. The surveillance and recording device through an original power outlet, according to claim 3, wherein the LED lamps are a visible light lamp or an infrared lamp.

6. The surveillance and recording device through an original power outlet, according to claim 1, wherein the lighting and photographing equipment is a night lamp used for night-time illumination.

7. The surveillance and recording device through an original power outlet, according to claim 6, wherein the night lamp is defined into a holding space to place the photographing device.

8. The surveillance and recording device through an original power outlet, according to claim 6, wherein a default location of the night lamp is defined into a lens that is connected with the photographing device.

9. The surveillance and recording device through an original power outlet, according to claim 6, wherein a default location of the night lamp is provided with a power connector that fits with an ordinary power outlet.
